(19) United States
(12) Patent Application Publication
(10) Pub. No.: US 2003/0180050 A1
(43) Pub. Date: Sep. 25, 2003

(54) OCDM system

(75) Inventor: Thomas Pfeiffer, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/358,836

(22) Filed: Feb. 6, 2003

(30) Foreign Application Priority Data
Mar. 25, 2002 (EP) 02360101.6

(51) Int. Cl. H04J 4/00

(52) U.S. Cl. 398/77; 398/43

(57) ABSTRACT

It is an object of the invention to provide an OCDM system which minimizes interferences in the system and maximizes the data throughput in a simple manner. The OCDM system according to the invention is particularly characterized in that the send rate of optical packets to be transmitted in optical channels is different for different optical nodes of the OCDM system. Each node of an OCDM system is allocated one optical channel, for example. Also allocated are the send rates of optical packets to be transmitted in the optical channels, for instance by transmitting an individual frequency to the node.

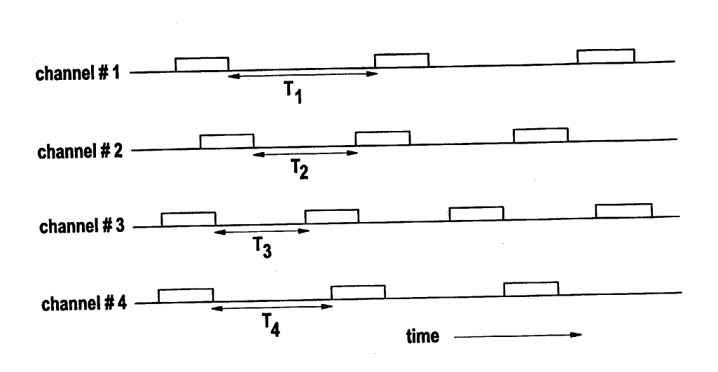

### TECHNICAL FIELD

This invention relates to an OCDM system. The invention is based on a priority application, EP 02360101.6, which is hereby incorporated by reference.

### BACKGROUND OF THE INVENTION

OCDM is based on spectral encoding of broadband optical sources; OCDM=Optical Code Division Multiplexing, also referred to as OCDMA=Optical Code Division Multiple Access. The light of a light-emitting diode (LED), modulated with data to be transmitted, is passed through an optical filter, for example, and thus encoded. At the transmitting end, several such LEDs and optical filter combinations are connected e.g. via an optical coupler to an erbium-doped fiber amplifier (EDFA) which is connected to an optical fiber. In this manner, differently encoded optical signals are generated which are transmitted together over the optical fiber. Via optical splitters, transmission can take place to two or more receiving ends. Each receiving end comprises, for instance, a differential receiver with a suitable optical filter for decoding the optical signals destined for the receiving end.

An optical filter is designed, for example, as a Mach-Zehnder filter. In the Mach-Zehnder filter, the received OCDM signal is routed over two paths having complementary transfer functions. The Mach-Zehnder filter can be used to both encode and decode OCDM signals.

At the transmitting end, one optical filter is used per optical transmission channel, for example. The optical filters of different channels must be properly detuned relative to each other so as to reduce crosstalk, for example. At the receiving end, use is made of an optical filter, for example, which is tuned to the optical transmission channel intended for the receiving end. The optical filters at the receiving end are tuned to the optical filters at the transmitting end.

The maximum number of simultaneously active optical channels is limited by the optical noise that originates from fluctuations and interferences of optical field vectors from different sources. Ideally, optical packets are transmitted only if they are to transmit user information. In that case, there is very little probability that two different optical packets arrive at a receiver at the same time, so that the interference level is low.

One possibility of keeping the interference level low is to use the so-called MAC protocol; MAC=Medium Access Control. By means of the MAC protocol, the number of simultaneously active optical channels is controlled. This largely prevents optical packets from arriving at the optical receivers at the same time. In this manner, system performance is enhanced and the level of optical noise in the system reduced. However, the MAC protocol requires rather complex communication between optical transmitters and receivers, and generally reduces the possible data throughput.

### SUMMARY OF THE INVENTION

It is an object of the invention to provide an OCDM system which minimizes interferences in the system and maximizes the data throughput in a simple manner.

This object is attained by an OCDM system comprising at least two nodes interconnected by optical lines, at least two nodes being allocated different send rates for sending optical packets.

This object is further attained by a method of transmitting OCDM signals wherein different send rates for sending optical packets are allocated to at least two nodes of an OCDM system, and wherein optical packets containing data to be transmitted are sent by each node at the send rate allocated to it.

This object is further attained by a node for an OCDM system comprising at least two nodes which are interconnected by optical lines, at least two nodes being allocated different send rates for sending optical packets, the node comprising a control adapted to receive optical packets of at least one send rate and to provide at least one send rate allocated to or generated in the node.

The OCDM system according to the invention is particularly characterized in that the send rate of optical packets to be transmitted in optical channels is different for different optical nodes of the OCDM system.

The invention is applicable to any network topology. The OCDM system is designed, for example, as a ring network, a star network, or a tree network.

The nodes of the OCDM system are designed as add/drop multiplexers or cross connects, for example. They can be both all-optical and opto-electric nodes. A node has, for instance, one or two adjacent nodes, with which it is connected by optical fibers. It contains an optical receiver for receiving optical signals and an optical transmitter for transmitting optical signals.

One embodiment of the invention and variants thereof will now be explained with reference to the accompanying drawing.

### BRIEF DESCRIPTION OF THE DRAWING

The single figure of the drawing is a pictorial representation of the distribution of transmitted optical packets over time for four optical channels.

### BEST MODE FOR CARRYING OUT THE INVENTION

Each node of an OCDM system is allocated one optical channel, for example. Also allocated are the send rates of optical packets to be transmitted in the optical channels. The send rate is the packet rate, not the bit rate. In the optical packets, user information, such as Internet data, telephone signals, broadband TV signals, are transmitted in coded form. The encoding is done by means of optical filters. The first node is allocated the optical channel #1 and the send rate 1/T₁, for example. The allocation of the send rate is accomplished, for example, by transmitting an individual frequency to the node. The second node is allocated the optical channel #2 and the send rate 1/T₂. The third node is allocated the optical channel #3 and the send rate 1/T₃, for example. The fourth node is allocated the optical channel #4 and the send rate 1/T₄, for example. The frequencies for the individual nodes, and hence their send rates, differ. As a result, at the receiving end, the time interval—the so-called guard band—between two optical packets from one node is different from the time interval between two optical packets from any other node. Consequently, in multichannel systems, the occurrence of interferences is minimized and, on an average, nearly constant.

The optimum choice of send rates follows from an algorithm which takes into account the number of optical channels to be used, the channel capacity, and the length of the optical packets; any length variations are also taken into account.

The idea of the invention is independent of the positions of transmitters and receivers in the network and of delay differences. Hence, it is independent of the network topology.

The send rates are advantageously chosen to lie in the upper kHz range or above. This minimizes inherent temporal variations in the gain of optical amplifiers and helps to stabilize the tuning in the optical receiver filter.

The send rates can advantageously be chosen so that the received optical packets do not overlap or that the probability of such overlapping is minimized. This can be done in at least the following three ways.

In a first variant, a fixed send rate is specified for each node. The send rates differ in relation to each other like prime numbers, for example. This minimizes the possibility of overlapping. Relative phase adjustment and fine control are not necessary.

In a second variant, each node comprises a random-number generator. The sending instants are determined at random. In each node, the random-number generator can generate sending instants from a different pool of numbers, for example. This gives a different average send rate for each node.

In a third variant, prior to the transmission of optical packets, each node checks independently whether the optical line is idle or busy, i.e., whether optical packets can be sent by the node without overlapping with other optical packets. An idle time slot is waited for, in which an optical packet to be transmitted is sent. For each node, a maximum send rate is specified to prevent system blocking by a node.

A system in accordance with the invention is configured as follows, for example.

The OCDM system comprises at least two nodes which are interconnected by optical fibers, at least two nodes being allocated different send rates for sending optical packets. The system is topology-independent and may be implemented with unidirectional or bidirectional links and with or without spare lines for alternate circuits. The number of nodes has a value between two and one thousand, for example.

The OCDM system is advantageously characterized in that a central node or a network management is provided which comprises a processor containing a specific computer program for controlling the allocation of send rates to nodes. The processor is, for instance, a digital signal processor or a microprocessor or forms part of the network management computer or network management server. The computer program is written in the programming language C++, for example. The algorithm specifies, for instance, that during system initialization, individual send rates are allocated to individual nodes. The allocation is accomplished, for example, via a temporary point-to-point link to, and by communication with, each of the nodes. An overview of all allocated send rates is stored centrally in the network management unit, for example, and may additionally be transferred to all nodes for local storage. Alternatively to the central control and allocation, an individual send rate may be allocated to each node already during installation of the nodes, e.g., by local programming. This has the advantage that the system functions by Plug and Play and without central control. In this variant, however, the send rates would be allocated permanently. Alternatively, a dynamic allocation of the send rates is possible, which can be changed from connection to connection and is made for the duration of an active transmission of information.

It is not imperative that all nodes or all optical channels should be assigned different send rates. The number of send rates may also be less than the number of optical channels, for example. Two nodes may, for instance, be allocated two different optical channels, but identical send rates. For each individual system, an optimum distribution of send rates, adapted to topology, number of optical channels, etc., is advantageous.

An extension of the system is possible in a simple manner by adding an additional node. The node is allocated an additional optical channel and an additional send rate, for example.

The OCDM system comprises at least one node having a control for detecting at least one received send rate and for controlling and providing a send rate allocated to the node. The control is designed as a programmed processor, for example. During synchronization or connection setup, in addition to the address of the node, information about the send rate is transmitted in the first optical packet, for example. The receiving node detects both its address and the send rate and tunes its receiver to data reception at a receive rate which corresponds to the detected send rate.

In the following, a method of transmitting OCDM signals in such an OCDM system is described.

Nodes of an OCDM system are allocated different send rates for sending optical packets. This can be done at a central or decentralized location during initialization or dynamically during connection setup. Each node transmits optical packets at the send rate allocated to it. The transmission takes place in an optical channel assigned to the node. For instance, five nodes are interconnected via optical fibers in a ring structure such that each node can send optical signals to any other node. Five optical channels, for example, are provided for the transmission of information. Each node is designed to use one of these optical channels as a send channel and four as receive channels. Each node has a different send channel. In addition to the different channels, five different send rates are allocated. For example, the first optical channel is assigned the first send rate, the second optical channel is assigned the second send rate, etc. With this fixed allocation, the first node sends optical signals in the first optical channel, with the optical packets therein being sent at the first send rate. In the second to the fourth nodes, the information that the first channel is assigned the first send rate is stored. The information is provided, for example, by a network management system or by a central node. Thus, in the fifth node, for example, optical signals are received in the first channel at a first receive rate, corresponding to the first send rate, in the second optical channel at a second receive rate, corresponding to the second send rate, etc.

In a preferred embodiment of the invention, a minimum send rate is provided for each node in the OCDM system. Each node then sends at its individual send rate optical packets which, when no user information is present, contain test signals or the like. The send rate can be increased for the transmission of user information, and lowered in the case of test signals, so that under the control of network management, for example, an adaptive adjustment is performed which minimizes possible interferences. Another advantage is that through continuous transmission, component drifts are avoided. Drifts are wavelength drifts, for example, if networks with laser sources are involved. Furthermore, existing closed-loop systems always receive an at least quasi-continuous signal which can be used for control purposes. Moreover, a minimum transmission capacity per channel can be guaranteed if correspondingly low send rates are chosen.

Another application consists in varying or setting a Quality of Service (QoS) via the send rate. Higher or reliable throughput can be achieved by increasing an individual send rate in an optical channel and, if necessary, simultaneously reducing the send rates in other channels. The central node or network management can control these QoS variations by means of a suitable algorithm. The central node or network management is designed to dynamically vary the send rates for individual nodes during operation in order to set different QoS classes. A node can also be assigned two or more send rates for the transmission of different QoS classes.

The invention can be used not only in an OCDM system but also in a WDM or DWDM system; WDM=Wavelength-Division Multiplexing, DWDM=Dense WDM. The send rates for optical packets which are transmitted by nodes on different wavelengths are allocated to the nodes as described above, e.g. by central allocation in the ratio of prime numbers or in any other ratio, in which case the send rates should not be too different, using random-number generators which generate the sending instants for individual nodes, or suitable detectors which test the state of the optical line and use an idle time slot for the transmission of optical packets.

1. An OCDM system comprising at least two nodes interconnected by optical lines, at least two nodes being allocated different send rates for sending optical packets.

2. An OCDM system as set forth in claim 1, wherein a central node or a network management is provided which comprises a processor containing a specific computer program for controlling the allocation of send rates to nodes.

3. An OCDM system as set forth in claim 1, wherein a central node or a network management is provided which is adapted to dynamically vary the send rates for individual nodes during operation in order to set different QoS classes.

4. An OCDM system as set forth in claim 1, wherein at least one node is provided which comprises a control for detecting at least one received send rate and for controlling and providing a send rate allocated to the node.

5. A method of transmitting OCDM signals wherein different send rates for sending optical packets are allocated to at least two nodes of an OCDM system, and wherein optical packets containing data to be transmitted are sent by each node at the send rate allocated to it.

6. A node for an OCDM system comprising at least two nodes which are interconnected by optical lines, at least two nodes being allocated different send rates for sending optical packets, the node comprising a control adapted to receive optical packets of at least one send rate and to provide at least one send rate allocated to or generated in the node.

7. A node as set forth in claim 6, wherein a random-number generator is provided for generating sending instants for optical packets to be transmitted.

8. A node as set forth in claim 6, wherein the node is adapted to determine independently prior to the sending of optical packets whether the optical line is idle or busy, and sends an optical packet in an idle time slot.
